(19) United States
(12) Patent Application Publication
(10) Pub. No.: US 2026/0274058 A1
(43) Pub. Date: Sep. 17, 2026

(54) FUEL CELL-EQUIPPED CARGO VEHICLE

(71) Applicant: HONDA MOTOR CO., LTD., TOKYO (JP)

(72) Inventor: Takuya KANDA, WAKO-SHI (JP)

(21) Appl. No.: 19/557,305

(22) Filed: Mar. 5, 2026

(30) Foreign Application Priority Data
Mar. 12, 2025 (JP) 2025-039418

(51) Int. Cl. B60K 1/04; H01M 8/04007

(52) U.S. Cl. CPC B60K 1/04; H01M 8/04074; B60K 2001/0411; B60K 2001/0422; B60Y 2200/14

(57) ABSTRACT

A fuel cell-equipped cargo vehicle includes a fuel cell module disposed below a cabin for accommodating an occupant, and a suspension disposed below the fuel cell module and suspending wheels (front wheels). The fuel cell module includes a fuel cell stack and a plurality of auxiliary devices provided for driving the fuel cell stack. The plurality of auxiliary devices include a lower-level auxiliary device disposed below the fuel cell stack. The lower end of at least one part of the lower-level auxiliary device is positioned below an upper end of the suspension.

### CROSS-REFERENCE TO RELATED APPLICATIONS

This application is based upon and claims the benefit of priority from Japanese Patent Application No. 2025-039418 filed on Mar. 12, 2025, the contents of which are incorporated herein by reference.

### BACKGROUND OF THE INVENTION

### Field of the Invention

The present disclosure relates to a fuel cell-equipped cargo vehicle.

### Description of the Related Art

In recent years, research and development have been conducted on fuel cells that contribute to energy efficiency in order to ensure accessibility to sustainable and modern energy. JP 2020-059299 A discloses a cargo vehicle equipped with a fuel cell module. The fuel cell module is disposed below the cabin.

### SUMMARY OF THE INVENTION

If the fuel cell module is disposed below the cabin while avoiding interference with the suspension, the fuel cell module interferes with the inclined portion on the lower front side of the cabin. Therefore, it is necessary to devise a way to arrange the fuel cell module below the cabin as in the case of the engine vehicle.

The present disclosure has the object of solving the aforementioned problem.

An aspect of the present disclosure is characterized by a fuel cell-equipped cargo vehicle including: a fuel cell module disposed below a cabin for accommodating an occupant; and a suspension disposed below the fuel cell module and suspending wheels, wherein the fuel cell module includes a fuel cell stack and a plurality of auxiliary devices provided for driving the fuel cell stack, the plurality of auxiliary devices include a lower-level auxiliary device disposed below the fuel cell stack, and a lower end of at least one part of the lower-level auxiliary device is positioned below an upper end of the suspension.

According to the fuel cell-equipped cargo vehicle of the present disclosure, the lower-level auxiliary device is disposed using the space around the upper portion of the suspension, and therefore the dimension of the fuel cell module in the front-rear direction can be reduced as compared with a fuel cell module that does not employ such an arrangement. Consequently, it is possible to avoid interference between the front part of the fuel cell module and the lower front side of the cabin.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is an overall schematic view of a fuel cell-equipped cargo vehicle according to an embodiment of the present disclosure; and

FIG. 2 is a diagram showing an arrangement of a cabin and a fuel cell module in the fuel cell-equipped cargo vehicle.

### DETAILED DESCRIPTION OF THE INVENTION

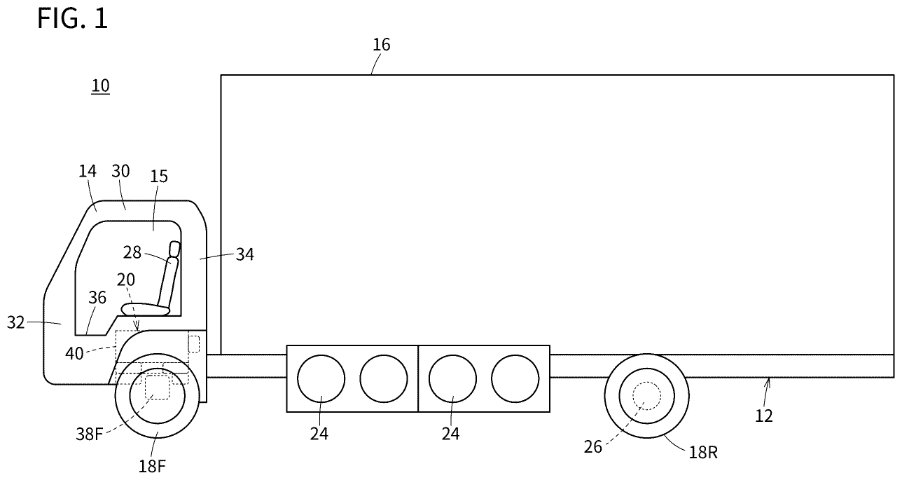

As shown in FIG. 1, a fuel cell-equipped cargo vehicle 10 according to the present embodiment includes a vehicle body frame 12, a cabin frame 14, a body 16, front wheels 18F, rear wheels 18R, a fuel cell module 20, fuel tanks 24, and a motor 26. Hereinafter, the front-rear direction of the fuel cell-equipped cargo vehicle 10 is referred to as a “vehicle front-rear direction”.

The vehicle body frame 12 extends in the vehicle front-rear direction. The cabin frame 14 is supported by the front end of the vehicle body frame 12. The cabin frame 14 is box-shaped and accommodates an occupant, and a seat 28 is disposed inside the cabin frame 14. The cabin frame 14 includes a ceiling 30, a front wall 32, a rear wall 34, and a floor wall 36. A space surrounded by the ceiling 30, the front wall 32, the rear wall 34, and the floor wall 36 is a cabin 15 for accommodating an occupant.

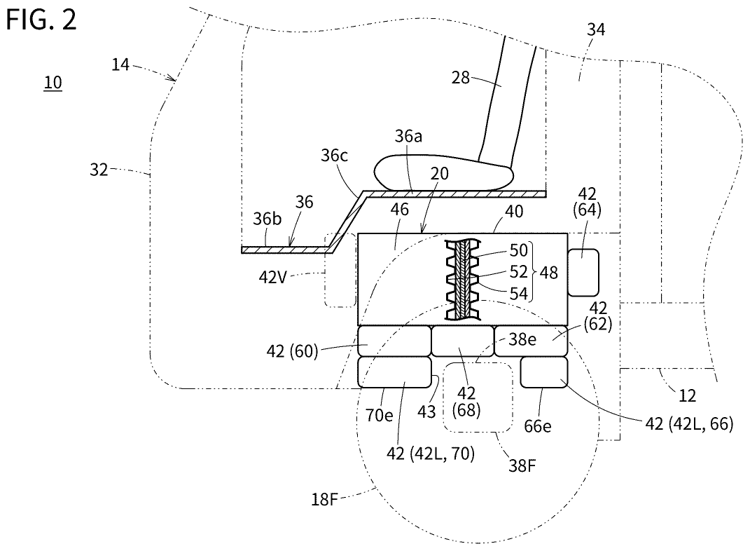

The floor wall 36 is provided at the lower portion of the cabin frame 14. As shown in FIG. 2, the floor wall 36 includes an upper level 36a, a lower level 36b, and an inclined portion 36c. The upper level 36a forms the rear part of the floor wall 36. The seat 28 is fixed on the upper level 36a. The lower level 36b forms the front part of the floor wall 36, and is positioned forward of the upper level 36a and also positioned below the upper level 36a. The front end of the upper level 36a and the rear end of the lower level 36b are connected via the inclined portion 36c. The inclined portion 36c is inclined downwards and forwards.

As shown in FIG. 1, the body 16 is fixed to the vehicle body frame 12 at a position rearward of the cabin frame 14. In the present embodiment, the body 16 is box-shaped, but may be flat-shaped (so-called flatbed type) without a roof. Cargo is stored in the body 16. The front wheels 18F are arranged below the cabin frame 14. The front wheels 18F are suspended from the front portion of the vehicle body frame 12 by a front suspension 38F. The rear wheels 18R are arranged rearward of the cabin frame 14 and the front wheels 18F, and positioned below the body 16. The rear wheels 18R are suspended from the vehicle body frame 12 by a rear suspension (not shown).

As shown in FIG. 2, the fuel cell module 20 is disposed below the cabin frame 14. The fuel cell module 20 includes a fuel cell stack 40 and a plurality of auxiliary devices 42 for driving the fuel cell stack 40. The fuel cell stack 40 includes a stack case 46 and a plurality of power generation cells 48. The stack case 46 accommodates the plurality of power generation cells 48.

The plurality of power generation cells 48 generate electrical power by electrochemical reactions between an anode gas (a fuel gas such as hydrogen or the like) that is supplied from an anode system device, and a cathode gas (an oxygen-containing gas such as air or the like) that is supplied from the cathode system device. Each of the power generation cells 48 includes a membrane electrode assembly 50, and two separators 52, 54 that sandwich the membrane electrode assembly 50. The plurality of power generation cells 48 are stacked in the vehicle front-rear direction with electrode surfaces thereof in an upright posture. The upper surface of the fuel cell stack 40 is located at a position higher than the lower level 36b of the floor wall 36.

The plurality of auxiliary devices 42 are provided for driving the fuel cell stack 40. Although not shown in detail, the plurality of auxiliary devices 42 include an air cleaner, a compressor 60, a humidifier, a heat exchanger, a plurality of pipes connecting these devices, valves provided in the pipes, electrical components, and the like. The plurality of auxiliary devices 42 representatively shown in FIG. 2 include at least the compressor 60, an inverter 62, a first heat exchanger 64, a second heat exchanger 66, a first pipe 68, and a second pipe 70.

The compressor 60 compresses air (outside air) introduced through the air cleaner. The compressor 60 is arranged below the fuel cell stack 40. The compressed air is supplied to the fuel cell stack 40 as cathode gas. The compressor 60 is arranged at a position higher than the suspension 38F.

The inverter 62 is disposed below the fuel cell stack 40. The inverter 62 is arranged at a position higher than the suspension 38F. The inverter 62 is disposed rearward of the compressor 60. The inverter 62 converts direct-current power generated by the fuel cell stack 40 into alternating-current power and supplies the alternating-current power to the motor 26 (FIG. 1). In an arrangement different from that shown in FIG. 2, the compressor 60 may be arranged on the rear side of the lower surface of the fuel cell stack 40, and the inverter 62 may be arranged on the front side of the lower surface of the fuel cell stack 40.

The first heat exchanger 64 performs heat exchange between air in a cathode system piping and cooling water in a cooling system piping, for example. The first heat exchanger 64 is arranged on the rear surface of the fuel cell stack 40. The second heat exchanger 66 performs heat exchange between air in the cathode system piping and cooling water in another cooling system piping, for example. The second heat exchanger 66 is arranged below the inverter 62. The second heat exchanger 66 is a lower-level auxiliary devices 42L disposed below the fuel cell stack 40. The second heat exchanger 66 is disposed rearward of the suspension 38F. The lower end 66e of the second heat exchanger 66 is positioned below the upper end 38e of the suspension 38F. The second heat exchanger 66 is a third lower-level auxiliary device that is positioned rearward of the suspension 38F in the vehicle front-rear direction of the fuel cell-equipped cargo vehicle 10 and has the lower end 66e located at a position lower than the upper end 38e of the suspension 38F.

The first pipe 68 is, for example, a part of the cathode system piping. The first pipe 68 is arranged below the fuel cell stack 40, and between the compressor 60 and the inverter 62. The first pipe 68 is arranged above the suspension 38F. The compressor 60, the first pipe 68, and the inverter 62 are first lower-level auxiliary devices that are disposed above the upper end 38e of the suspension 38F. The second pipe 70 is a lower-level auxiliary devices 42L arranged below the fuel cell stack 40. The second pipe 70 is, for example, another part of the cathode system piping. The second pipe 70 is arranged forward of the suspension 38F. The lower end 70e of the second pipe 70 is positioned below the upper end 38e of the suspension 38F. The second pipe 70 is a second lower-level auxiliary device that is positioned forward of the suspension 38F in the vehicle front-rear direction of the fuel cell-equipped cargo vehicle 10 and has the lower end 70e located at a position lower than the upper end 38e of the suspension 38F. Each of the first pipe 68 and the second pipe 70 may be a part of an anode system piping. Each of the first pipe 68 and the second pipe 70 may be a part of the cooling system piping.

In this manner, the upper portion of the suspension 38F is arranged between two auxiliary devices 42 (in the present embodiment, the second pipe 70 and the second heat exchanger 66) among the plurality of auxiliary devices 42. A recess 43 is formed by a plurality of auxiliary devices 42 below the fuel cell module 20, and the upper end 38e of the suspension 38F is positioned within the recess 43. That is, the lower-level auxiliary devices 42L are disposed on both sides of the suspension 38F in the vehicle front-rear direction. The auxiliary devices 42 disposed in the front and rear of the upper portion of the suspension 38F among the plurality of auxiliary devices 42 may be auxiliary devices 42 other than the second pipe 70 and the second heat exchanger 66.

The fuel tanks 24 shown in FIG. 1 store fuel gas (for example, hydrogen gas). The fuel tanks 24 are supported by the vehicle body frame 12 at a lower part of the body 16. Fuel gas is supplied from the fuel tanks 24 to the fuel cell module 20. The fuel tanks 24 may be disposed inside the body 16.

The motor 26 is operated by electrical power supplied from the fuel cell module 20, and drives the rear wheels 18R. The motor 26 is fixed to the vehicle body frame 12 at a lower part of the body 16, for example. The motor 26 may be disposed below the cabin frame 14, and the rotational driving force of the motor 26 may be transmitted to the rear wheels 18R via a drive shaft.

The present embodiment exhibits the following advantageous effects.

As shown in FIG. 2, in the fuel cell-equipped cargo vehicle 10, the plurality of auxiliary devices 42 include lower-level auxiliary devices 42L arranged below the fuel cell stack 40. The lower-level auxiliary devices 42L have lower ends 66e, 70e located at positions lower than the upper end 38e of the suspension 38F. According to such an arrangement, the lower-level auxiliary devices 42L are disposed using the space around the upper portion of the suspension 38F, and thus the size of the fuel cell module 20 in the front-rear direction can be reduced as compared with a fuel cell module that does not employ such an arrangement. Consequently, it becomes possible to avoid interference between the front part of the fuel cell module 20 and the lower front side (the inclined portion 36c) of the cabin frame 14. On the other hand, if an auxiliary devices 42V is disposed in front of the fuel cell module 20 as indicated by the imaginary line in FIG. 2 in a case of an arrangement different from the present embodiment, the auxiliary device 42V interferes with the lower portion (the inclined portion 36c) of the cabin frame 14, and therefore, such a fuel cell module 20 cannot be disposed below the cabin frame 14.

The lower-level auxiliary devices 42L are disposed such that the suspension 38F is interposed therebetween in the vehicle front-rear direction. According to such an arrangement, a large number of auxiliary devices 42 can be disposed in the fuel cell module 20 while avoiding the suspension 38F and suppressing an increase in the vehicle height.

The lower-level auxiliary devices 42L include a heat exchanger (second heat exchanger 66) and a pipe (second pipe 70). According to such an arrangement, since the heat exchanger and the pipe are disposed adjacent to the front and rear of the suspension 38F, the position of the front part of the fuel cell module 20 can be shifted rearward as compared with a fuel cell module that does not employ such an arrangement. Consequently, it becomes possible to avoid interference between the front part of the fuel cell module 20 and the lower front side of the cabin frame 14.

In relation to the above-described embodiment, the following supplementary notes are further disclosed.

### Supplementary Note 1

The fuel cell-equipped cargo vehicle (10) according to the present disclosure including: the fuel cell module (20) disposed below the cabin (14) for accommodating an occupant; and the suspension (38F) disposed below the fuel cell module and suspending wheels, wherein the fuel cell module includes the fuel cell stack (40) and the plurality of auxiliary devices (42) provided for driving the fuel cell stack, the plurality of auxiliary devices include a lower-level auxiliary device (42L) disposed below the fuel cell stack, and the lower end (66e, 70e) of at least one part of the lower-level auxiliary device is positioned below the upper end (38e) of the suspension. According to such an arrangement, the lower-level auxiliary device is disposed using the space around the upper end of the suspension, and thus the size of the fuel cell module in the front-rear direction can be reduced as compared with a fuel cell module that does not employ such an arrangement. Consequently, it is possible to avoid interference between the front part of the fuel cell module and the lower front side of the cabin.

### Supplementary Note 2

In the fuel cell-equipped cargo vehicle according to Supplementary Note 1, the lower-level auxiliary devices may include a plurality of the lower-level auxiliary devices disposed so as to interpose the suspension in a vehicle front-rear direction of the fuel cell-equipped cargo vehicle. According to such an arrangement, a large number of auxiliary devices can be disposed in the fuel cell module while avoiding the suspension and suppressing an increase in the vehicle height.

### Supplementary Note 3

In the fuel cell-equipped cargo vehicle according to Supplementary Note 2, the lower-level auxiliary devices may include a heat exchanger and a pipe. According to such an arrangement, since the heat exchanger and the pipe are disposed adjacent to the front and rear of the suspension, the front part of the fuel cell module can be shifted rearward as compared with a fuel cell module that does not employ such an arrangement. Consequently, it is possible to avoid interference between the front part of the fuel cell module and the lower front side of the cabin.

### Supplementary Note 4

In the fuel cell-equipped cargo vehicle described in Supplementary Note 2, the lower-level auxiliary devices may include a first lower-level auxiliary device disposed above the upper end of the suspension, a second lower-level auxiliary device disposed forward of the suspension in the vehicle front-rear direction of the fuel cell-equipped cargo vehicle and having a lower end positioned below the upper end of the suspension, and a third lower-level auxiliary device disposed rearward of the suspension in the vehicle front-rear direction of the fuel cell-equipped cargo vehicle and having a lower end positioned below the upper end of the suspension. Further, an important auxiliary component in the fuel cell system may be applied as the first lower-level auxiliary device, and components having relatively low importance compared to the first lower-level auxiliary device may be applied as the second lower-level auxiliary device and the third lower-level auxiliary device. According to such an arrangement, even when the suspension is tilted due to a collision at a lower portion of the vehicle, it is possible to protect the first lower-level auxiliary device and absorb the impact caused by the collision, while allowing many auxiliary devices to be arranged with an increase in the height of the vehicle suppressed.

Although concerning the present disclosure, a detailed description thereof has been presented above, the present disclosure is not necessarily limited to the individual embodiments described above. These embodiments may be subjected to various additions, substitutions, modifications, partial deletions and the like, within a range that does not deviate from the essence and gist of the present disclosure, or the spirit of the present disclosure as derived from the contents described in the claims and equivalents thereof. Further, the embodiments can also be implemented together in combination. For example, in the above-described embodiments, the order of each of the operations and the order of each of the processes are illustrated as examples, and the present invention is not necessarily limited to these features. The same also applies to cases in which numerical values or mathematical expressions are used in the description of the aforementioned embodiments.

1. A fuel cell-equipped cargo vehicle comprising:
a fuel cell module disposed below a cabin for accommodating an occupant; and
a suspension disposed below the fuel cell module and suspending wheels, wherein
the fuel cell module includes a fuel cell stack and a plurality of auxiliary devices provided for driving the fuel cell stack,
the plurality of auxiliary devices include a lower-level auxiliary device disposed below the fuel cell stack, and
a lower end of at least one part of the lower-level auxiliary device is positioned below an upper end of the suspension.

2. The fuel cell-equipped cargo vehicle according to claim 1, wherein the lower-level auxiliary device includes a plurality of lower-level auxiliary devices disposed so as to interpose the suspension in a vehicle front-rear direction of the fuel cell-equipped cargo vehicle.

3. The fuel cell-equipped cargo vehicle according to claim 2, wherein the lower-level auxiliary devices include a heat exchanger and a pipe.

4. The fuel cell-equipped cargo vehicle according to claim 2, wherein
the lower-level auxiliary devices include a first lower-level auxiliary device disposed above the upper end of the suspension,
a second lower-level auxiliary device disposed forward of the suspension in the vehicle front-rear direction of the fuel cell-equipped cargo vehicle and having a lower end positioned below the upper end of the suspension, and
a third lower-level auxiliary device disposed rearward of the suspension in the vehicle front-rear direction of the fuel cell-equipped cargo vehicle and having a lower end positioned below the upper end of the suspension.
